(19) United States
(12) Patent Application Publication
(10) Pub. No.: US 2010/0272883 A1
(43) Pub. Date: Oct. 28, 2010

(54) METHODS FOR VOC-REDUCED PRETREATMENT OF SUBSTRATES AND DETECTION BY LUMINESCENCE

(76) Inventors: Thomas Wirz, Zurich (CH); Reto Faessler, Appenzell (CH); Philip E. Weber, Novi, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/833,426

(22) Filed: Jul. 9, 2010

Related U.S. Application Data
(63) Continuation of application No. 10/971,925, filed on Oct. 22, 2004.

(51) Int. Cl. B05D 1/00

(52) U.S. Cl. 427/8

(57) ABSTRACT

The present invention comprises methods for the pretreatment of substrates, including without limitation, metal or glass surfaces, with activators of reduced VOC content. Preferred embodiments of the invention comprise activators containing methyl acetate as a solvent, at least one adhesion promoter, and a luminescent agent responsive to light of specific wavelengths. In some embodiments, without limitation, an activator composition of reduced VOC content and also comprising a luminescent agent is applied to a substrate before application of additional adhesives or paints, and the substrate is examined under a controlled light source as required to excite the luminescent agent. The luminescent agent in the activator composition appears distinctly where the activator has been applied to the surface, allowing one to detect whether the activator has been properly applied.

### FIELD OF THE INVENTION

The invention relates to the field of pre-treating substrates, including without limitation, metal and glass surfaces, in order to enhance the binding of paints, adhesives, or other compositions to those substrates.

### BACKGROUND OF THE INVENTION

Currently painting and adhesion methods used in many applications, including without limitation, vehicular applications, include pigmented activators that contain large amounts of carbon black filler. Such activators also contain large amounts of volatile organic compounds (“VOC's”), such as solvents. VOC's are the subject of many stringent environmental regulations, for example, air pollution regulations.

Activators that are clear in color are also used in many applications. However, when a clear activator is used, often one cannot confirm visually whether the activator has been properly applied to the substrate in use. Even when a black activator is used, one often cannot confirm that the activator that had been applied was the correct chemical. Without proper application of the appropriate activator, paints or adhesives may not stick to the surface, and the substrate may fail to bind the applied chemical properly, resulting in a risk of product failure and safety issues, as well as potential leaks and other damage, production delays, or other unwanted expense.

It would be desirable to use activators with reduced VOC content in order to minimize the effort and cost of compliance with otherwise applicable regulations. It would also be desirable to have a simple-to-use method for determining whether correct activators have been properly applied. Thus, there remains a need for novel methods and compositions to pretreat substrates with activators with decreased VOC content and to determine whether the activators have been properly applied.

### SUMMARY OF THE INVENTION

The present invention meets this unmet need by comprising methods for the pretreatment of substrates, including without limitation, metal or glass surfaces, with activators of reduced VOC content. Preferred embodiments of the invention comprise activators containing methyl acetate as a solvent, at least one adhesion promoter, and a luminescent agent responsive to light of ultraviolet or other wavelengths. In accordance with the invention, an activator composition of reduced VOC content and also comprising a luminescent agent is applied to a substrate before application of additional adhesives or paints, and the substrate is examined under a light source where the wavelength of light is matched to the excitation wavelength of the photo-initiators in a luminescent agent. The luminescent agent in the activator composition appears distinctly where the activator has been applied to the surface, allowing one to detect whether the activator has been properly applied.

Other aspects of the invention will be apparent to those skilled in the art after reviewing the drawings and the detailed description below.

### BRIEF DESCRIPTION OF THE DRAWINGS

The present invention will now be described, by way of example, with reference to the accompanying drawings, in which:

FIG. 1 is a diagram of a glass/metal application of an activator composition containing a luminescent agent.

FIG. 2 is a diagram of a preferred adhesive bead application.

FIG. 3 is a diagram of one possible configuration of a luminescent detection system.

FIG. 4 shows the results of testing activator samples containing different concentrations of luminescent agent.

FIG. 5 is a photograph of a lighting configuration for one tested embodiment, without limitation, of a detection system.

FIG. 6 is a photograph of one tested embodiment, without limitation, of a detection system showing placement of a detection camera.

FIG. 7 is a photograph showing application of a luminescent activator to a vehicle chassis.

FIG. 8 is an image from a detection system showing pixel detection configuration.

FIG. 9 is an image from a detection system showing the results of testing an application of an activator containing a luminescent agent to a vehicle windshield frame, without certain intentional omissions in the application.

### DETAILED DESCRIPTION

The present invention comprises methods whereby one can detect whether activators have been properly applied to substrates. In preferred embodiments, a luminescent agent is added to an activator. The activator is applied to a substrate to be painted or further processed, and a light source is passed over the substrate causing the agent to luminesce before any adhesive bead or additional coating or paint is applied.

In preferred embodiments, without limitation, the invention is comprised of a composition containing an activator with at least one adhesion promoter, methyl acetate, and a luminescent agent.

As used herein, the term “activator” or “activator composition” means a chemical solution that contains at least one adhesion promoter. Adhesion promoters are known to those of ordinary skill in the art and are generally substances which are applied to a substrate to improve the adhesion of another chemical or compound to the substrate. In some known forms, without limitation, an adhesion promoter is a material placed in a thin layer at the interface of two dissimilar materials in order to enhance bonding between the materials, often either by interdiffusion or by chemical bonding.

In some embodiments, without limitation, the activator may comprise at least one adhesion promoter selected from the group consisting of organo silicon compounds, organo titanium compounds and organo zirconium compounds.

Preferably the organo silicon compound carries at least one substituent which is hydrolysed by water leading to the formation of silanols. Preferably said organo silicon compound carries at least one, preferably at least two alkoxy sub stituents, which are bound directly to the silicon atom by a silicon-oxygen bond. Furthermore said organo silicon compound carries at least one substituent which is bound directly to the silicon atom by a silicon-carbon bond and which comprises optionally a reactive group selected from the group consisting of oxirane, hydroxyl, (meth)acryloxy-, amino-, mercapto-und vinyl group. Particularly said organo silicon compound has the chemical formula (I)

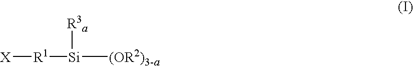

in which the substituent R¹ is a linear or branched alkylene or cycloalkylene with 1 to 20 carbon atoms, optionally which aromatic parts, and optionally with one or more hetero atoms, particularly one or more nitrogen atoms; and in which the substituent R² is an alkyl with 1 to 5 carbon atoms, preferably methyl or ethyl; and in which the substituent R³ is an stands an alkyl with 1 to 8 carbon atoms, preferably methyl or ethyl; and in which X is H or a substituent selected from the group consisting of oxirane, OH, (meth)acryloxy, amino, SH and vinyl; and in which a is 0, 1 or 2. Preferably a is 0. Further preferred the substituent R¹ is methylene-, propylene-, methylpropylene, butylene or dimethylbutylene. The most preferred R¹ is propylene.

Suitable organo silicon compounds are commercially available and are preferred to be selected from the group comprising 3-methacryloxypropyltrialkoxysilane, 3-amino propyltrimethoxysilane, bis-[3-(trimethoxysilyl)-propyl]-amine, tris-[3-(trimethoxysilyl)-propyl]-amine, 3-aminopropyltriethoxysilane, N-(2-aminoethyl)-3-aminopropyl-trimethoxysilane, N-(2-aminoethyl)-3-aminopropyl-triethoxysilane, 3 -aminopropyl-dimethoxymethylsilane, 3-amino-2-methylpropyl-trimethoxysilane, 4-aminobutyl-trimethoxysilane, 4-amino butyl-dimethoxymethylsilane, 4-amino-3-methylbutyl-trimethoxysilane, 4-amino-3,3-dimethylbutyl-trimethoxysilane, 4-amino-3,3-dimethylbutyl-dimethoxymethylsilane, 2-aminoethyl-trimethoxysilane, 2-aminoethyl-dimethoxymethylsilane, aminomethyl-trimethoxysilane, aminomethyl-dimethoxymethyl-silane, aminomethylmethoxydimethylsilane, N-(a-Aminoethyl)-3-aminopropyl-dimethoxymethylsilane, 7-amino-4-oxaheptyldimethoxymethylsilane, (3-(trimethoxysilyl)propyl]urea, 1,3,5-tris[3-(trimethoxysily)propyl]-1,3,5-triazine-2,4,6(1H,3H,5H)-trion-urea (=isocyanurate of 3-isocyanatopropyltrimethoxy-silane), 3-methacryloxypropyltriethoxysilane, 3-methacryl oxypropyltrimethoxysilane, 3-glycidyl-oxypropyltrimethoxysilane, 3-glycidyloxypropyltriethoxysilane, 3-mercaptopropyl-triethoxysilane, 3-mercaptopropyltrimethoxysilane, vinyltrimethoxysilane, vinyltriethoxy-silane, methyltrimethoxysilane, octyltrimethoxysilane, do decyltrimethoxysilane, hexa-decyltrimethoxysilane and adducts of epoxysilanes with mercaptosilanes or with aminosilanes.

Preferred adducts of epoxysilanes with aminosilane or mercaptosilanes are those as disclosed as reaction products D in EP 1 382 625 A1.

Preferred organo silicon compound are aminosilanes, more preferably primary aminosilanes, most preferred 3-amino propyltrimethoxysilane, 3-amino propyltri-ethoxysilane, N-(2-aminoethyl)-3-aminopropyl-trimethoxysilane, N-(2-amino ethyl)-3-amino propyl-triethoxysilane and mixtures thereof.

Preferably the organo titanium compound carries at least one substituent which is hydrolysed by water leading to the formation of Ti—OH groups. Preferably said organo titanium compound carries at least one substituent which is selected from the group comprising alkoxy, sulfonate, carboxylate, acetylacetonate, and mixtures thereof, and which is bound directly to the titanium atom by means of a titanium-oxygen bond.

Preferred alkoxy are the so-called neoalkoxy substituents of the following formula:

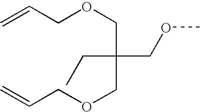

Aromatic sulfonates, in which the aromatic part is further substituted by an alkyl, are preferred among the sulfonate substituents. Most preferred sulfonates are those of the following formula:

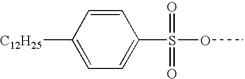

Carboxylates of fatty acids are preferred carboxylate groups. Most preferred carboxylate substituents are decanoates.

The dotted line in the above formulas shows the bond to the titanium atom.

Preferably said organo titanium compounds are commercially available organo titanium compounds from Kenrich Petrochemicals or DuPont. Suitable examples thereof are Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA1, LICA 09, LICA 12, LICA 38, LICA 44, LICA 97, LICA 99, KR OPPR, KROPP2 by Kenrich Petrochemicals or Tyzor ® ET, TPT, NPT, BTM AA, AA-75, AA-95, AA-105, TE, ETAM von DuPont. Preferred organo titanium compounds are Ken-React® KR 7, KR 9S, KR 12, KR 26S, KR 38S, KR44, LICA 09, LICA 44, NZ 44, and Tyzor® ET, TPT, NPT, BTM, AA, AA-75, AA-95, AA-105, TE, ETAM by DuPont.

Preferably the organo zirconium compound carries at least one substituent which is hydrolysed by water leading to the formation of Zr—OH groups. Preferably said organo zirconium compound carries at least one substituent which is selected from the group comprising alkoxy, sulfonate, carboxylate, phosphate and mixtures thereof, and which is bound directly to the zirconium atom by means of a zirconium-oxygen bond.

Preferred alkoxy are isopropoxy and the so-called neoalkoxy substituents of the following formula:

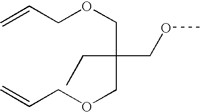

Aromatic sulfonates, in which the aromatic part is further substituted by an alkyl, are preferred among the sulfonate substituents. Most preferred sulfonates are those of the following formula:

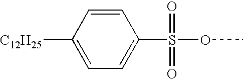

Carboxylates of fatty acids are preferred carboxylate groups. Most preferred carboxylate substituents are stearates.

The dotted line in the above formulas shows the bond to the zirconium atom.

Preferably said organo zirconium compounds are commercially available organo zirconium compounds from Kenrich Petrochemicals. Suitable example thereof are NZ 38J, NZ TPPJ, KZ OPPR, KZ TPP, NZ 01, NZ 09, NZ 12, NZ38, NZ 44, NZ 97 by Kenrich Petrochemicals. Preferred is Ken-React® NZ 44.

The activator may comprise a mixture of at least one organo titanium compound and at least one organo zirconium compound. The activator may also comprise a mixture of at least one organo silicon compound and at least one organo titanium compound and/or at least one organo zirconium compound. Preferred activators comprise a mixture of at least one organo silicon compound and at least one organo titanium compound. Preferred activators also comprise a mixture of several organo silicon compounds or mixtures of organo silicon compound and at least one organo titanium compound.

Preferred mixtures of organo silicon compounds are mixtures of organo silicon compounds of formula (I). Commercially available activators include, without limitation, Betawipe VP 04604 or BZW 04605 (DOW Automotive; silanes in isopropanol); Terostat 8540 (Teroson; silanes in isopropanol); Togocoll W000/6462 (EFTEC; silanes in ethanol); and Sika Activator (Sika Corp., Madison Heights, Mich.).

An adhesion promoter often comprises small molecules with different reactive groups. One group may react with the substrate, while the other reacts with another compound to form a link between the substrate and the adhesive. Thus, adhesion promoters provide reactive species at the surface of the substrate, anchoring to the substrate while leaving another reactive site to which an adhesive, paint, or other compound can attach when applied to the surface. As some examples, without limitation, silanes and titanates can act as adhesion promoters in part due to hydrolysis in the presence of moisture to silanols, titanols, and other reactive species.

Many suitable activators are known to those of ordinary skill in the art and are commercially available, including without limitation, SikaActivator® UH-2, Sika Primer® 206 G&P, Sika Primer® 206 OT, and SikaPrimer® 209 (Sika Corporation, Madison Heights, Mich.).

Suitable luminescent agents are those that glow or fluoresce on exposure to ultraviolet light or to light of other wavelengths matched to the excitation wavelength of the photo-initiators in the luminescent agent. The excitation wave length of the light source should be used according to the absorption spectrum of the selected luminescent material. Many luminescent agents will be known to those of ordinary skill in the art and are commercially available, as one example without limitation, Uvitex ® OB (Ciba Specialty Chemicals, Tarrytown, N.Y.), which is preferred. Commercially available luminescent agents, especially those used as whitening agents, include those available under the trademarks Lumilux® by Riedel-de Haen GmbH, Blankophor® from Bayer, Uvitex® from Ciba Specialty Chemicals. Other fluorescent brighteners are described in the 11 Kirk-Othmer Encyclopedia of Chemical Technology (John Wiley & Sons, 4^{th} Ed., 1994) at pp. 227-241. See also U.S. Pat. No. 6,461,326 B1 (Col. 6), which is hereby incorporated in full by reference.

In some embodiments, the present invention comprises combinations of certain VOC's with activator chemicals and luminescent agents. The prior art includes black activators that contain much carbon black as well as solvents that are regulated under U.S. Environmental Protection Agency regulations. In contrast, by using solvents classified as VOC-exempt under applicable regulations (see for example, 40 C. F. R. § 51.100(s)(I)), embodiments of the present invention provide the advantage of a significant reduction of the VOC content. Thus, in some embodiments, the invention comprises an activator in a VOC-compliant solvent and a luminescent agent.

In accordance with the invention, an activator composition containing a luminescent agent may be applied robotically or manually, for example, wipe- or spray-applied, to a surface. Generally a monolayer of the activator is desirable for optimal results. The process of wiping and spraying may be repeated. The quality of activator application is checked by viewing the application surface under an ultraviolet light, such as a “black light,” or light of other appropriate wavelength, according to methods known to those of ordinary skill in the art. These methods can include manual methods, as well as automated methods, where the application area is imaged and assessed automatically.

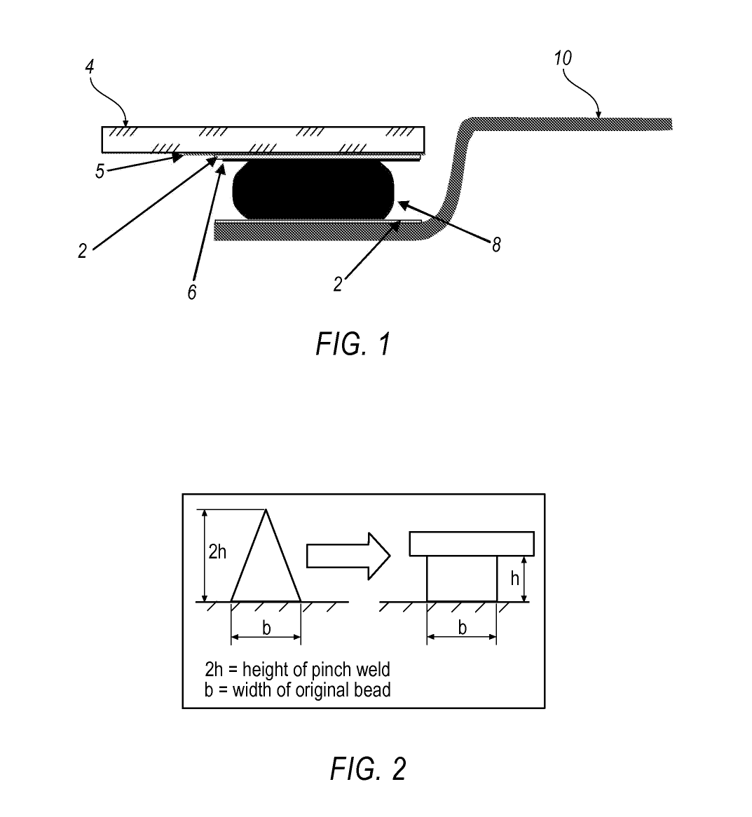

As one example of a glass application (FIG. 1), without limitation, Sika Aktivator® UH-2 LUM, an activator containing a luminescent agent 2, is applied at a temperature above 40° F. to a bonding area on clean glass surface 4, using an IPA solvent or other approved solvent to clean the surface if required. The glass surface may include but is not limited to a glass substrate comprised, at the user's option, of a ceramic frit 5 or similar surface known to those of ordinary skill in the art. The Sika Aktivator® 2 is poured on a clean lint-free dry cloth or applied by felt tip applicator, as known to those of ordinary skill. The Sika Aktivator® 2 is applied or wiped on in a continuous direction on the bonding area and immediately wiped off with the recommended lint free dry cloth. SikaPrimer® 2060T, a primer 6, is then applied at a temperature above 40° F. over the SikaAktivator® 2 in a continuous film in one direction using a “dauper” or a felt tip applicator. The dry time for the Sika Primer® 2060T 6 is a minimum of 2 minutes prior to applying the Sikaflex® 250 UH-1 cool adhesive 8. Sika Primer® 2060T 6 has 90 days open time. Sikaflex® 250 UH-1 8 is then cold-applied. The seal is completely punctured on the top of the cartridge, with a V-cut nozzle on the cartridge, and the cartridge is placed in a dispenser gun. A triangular bead of adhesive is applied over the existing Sika Primer® 2060T 6 (See FIG. 2). The windshield glass 4 is assembled to the body within 15 minutes. Sikaflex® 250 UH-1 8 has a recommended maximum open time of 15 minutes (23° C. and 50% R. H.) Sikaflex® 250UH-1 8 adhesion can be checked after a recommended minimum of 7 days @ 23° C. and 50% R. H.

As an example of a metal application (FIG. 1), without limitation, SikaAktivator® UH-2 LUM 2 is applied at a temperature above 40° F. to the bonding area on clean metal body surface 10, using an approved IPA solvent or other approved solvent to clean the surface if required. The metal surface 10 may include but is not limited to a metal substrate comprised of one or more coated or painted layers, by way of examples only and without limitation, an electrostatically applied primer layer, a painted top coat layer, or other permutations comprising one or more paint layers. The Sika Aktivator® 2 is applied with a clean lint free dry cloth or with a felt tip applicator. The SikaAktivator® 2 is wiped on in a continuous direction on the bonding area and immediately wipe off with the recommended lint free dry cloth.

Areas where the correct activator has been properly applied will glow under a controlled light due to the presence of the luminescent agent. This permits the operator to evaluate the quality of the activator application simply and quickly. After inspection, an adhesive or other coating may be applied to the pinch weld that has been coated with the activator, and the production process may continue.

Thus, in some embodiments, without limitation, the invention comprises methods to determine whether the correct activators have been properly applied to the desired substrates. This is particularly true, for example, in assembly line environments, where it is important to know whether production steps have been performed properly. Embodiments of the invention will assist the user in evaluating whether the chosen paint, adhesive or other coating applied to the substrate will properly perform its anticipated function, whether that function is operational, protective, cosmetic, or safety-related. As one example only, without limitation, some embodiments of the invention may assist the user in evaluating whether adhesive systems for vehicular windshields have been properly applied, thus permitting the user to assess whether good, durable adhesion will hold the windshield in place as desired.

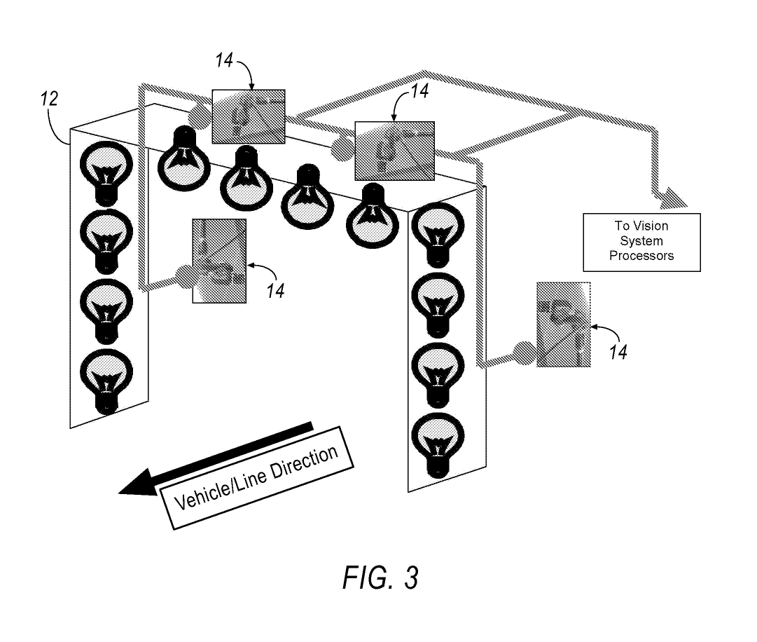

As one example only, without limitation, in accordance with the invention, a luminescent detection system may comprise a lighting source 12 to excite photo-initiators in the luminescent agents that have been added into the activator; one or more digital cameras 14 with lenses and or filters that identify light radiated at a specific wavelength by the luminescent agents; and a PC-based vision system (not shown) that receives the output from the digital camera and measures the presence of light emitted by the luminescent agents (FIG. 3). The system may have the software and hardware capability to identify coverage area and surface density of the activator by detecting and measuring the amount emitted light.

The invention comprises methods of evaluating the selective distribution of activators containing luminescent agents to substrates. In some embodiments, without limitation, the selective distribution of such activators may be observed by illumination of the substrate with a light source of appropriate wavelength and visual observation of the substrate by the user, as one example only, by passing a handheld light source over the substrate and visually assessing the degree of luminescence, if any. In other embodiments, without limitation, the detection system may be a stationary system in which a vehicle moving on an assembly line travels into a measurement zone comprising an appropriate light source and visual, electronic, and/or automated detection means. In still other embodiments, the detection system may be a moving system in which automated detection means, as one example only, one or more digital cameras and a light source of appropriate wavelength are attached at the end of one or more robotic arms and used in close proximity to the surface to be tested in order to detect presence of the luminescent activator. Without limiting the invention, other embodiments may include various combinations of features of the embodiments described herein.

Without limitation, preferred embodiments of the invention comprise the use of a clear activator as opposed to a pigmented activator. Pigmented activators tend to form a visible mess if they are leaked or dripped into the compartment of the vehicle under assembly. If the pinch weld leaks and a pigmented activator were used, the interior might be damaged. This leaves an undesirable mess to be cleaned up inside the vehicle. With the clear compositions of the present invention, there is less risk of a mess and less visibility at the pinch weld, while at the same time, a method to detect proper activator application is provided.

### EXAMPLES

SikaActivator® UH-2, a commercially available clear activator containing methyl acetate, was obtained. Different formulations of a clear activator composition containing a luminescent agent were prepared as follows:

SikaActivator® UH-2+0.05% Uvitex OB (“SikaActivator® UH-2 LUM I”)

SikaActivator® UH-2 +0.15% Uvitex OB (“SikaActivator® UH-2 LUM II”)

SikaActivator® UH-2+0.30% Uvitex OB (“SikaActivator® UH-2 LUM III”)

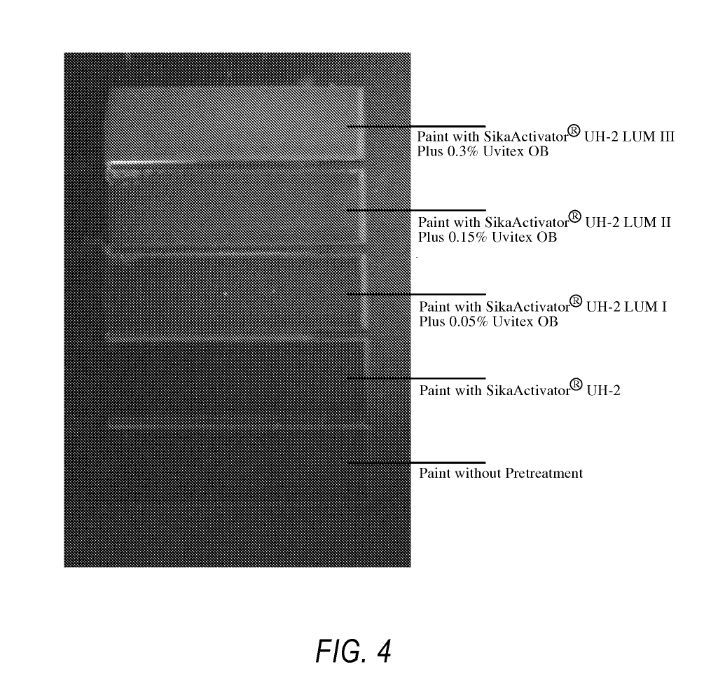

Uvitex OB, a luminescent agent, was dissolved in the SikaActivator® UH-2 at room temperature. Visibility of the SikaActivator® UH-2 LUM variations was tested under a light source generating a wavelength of about 375 nm in a darkened enclosure or room. The testing showed that the visibility of the luminescent agent increased in proportion to its concentration (FIG. 4).

Testing with different UV-lamps and filters showed that best results were obtained with a UV-lamp with wavelength around 375 nm (testing lamp at around 366 nm). The power of the lamp should be at least 8 W. For using digital cameras, which are UV-sensitive, filters are necessary. Best results were obtained using 400 nm or 420 nm filters (absorbing wavelengths under 400 nm/420 nm).

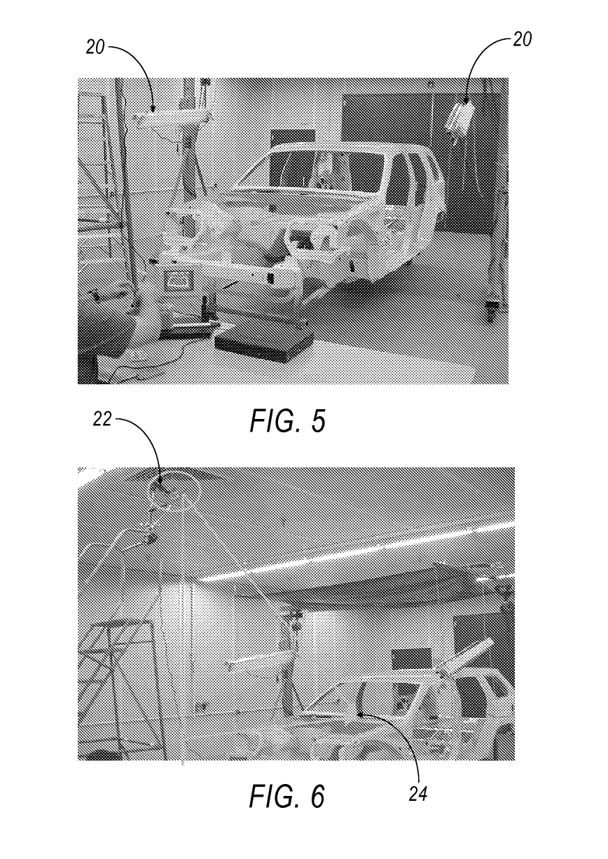

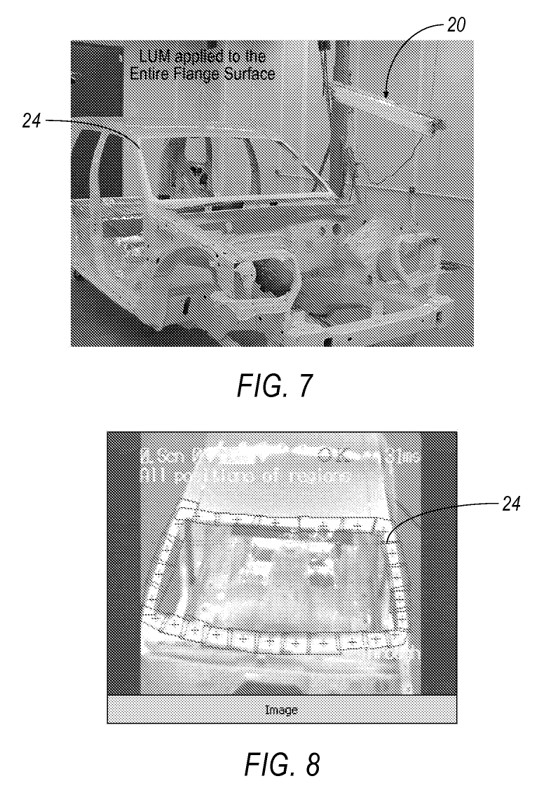

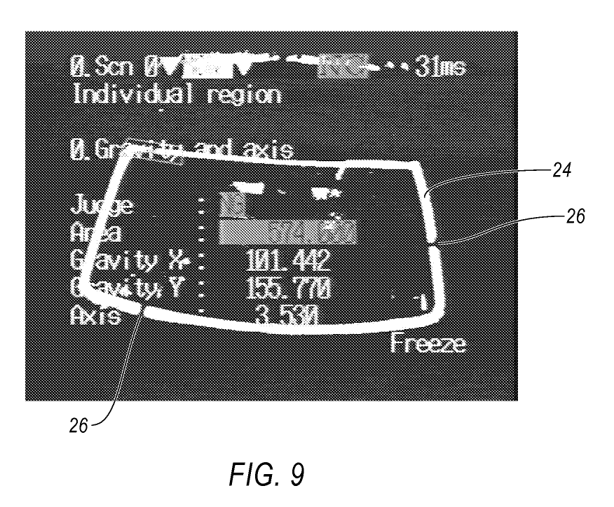

In one tested detection system, without limitation, fluorescent light fixtures 20 were mounted at an elevation of about 1.4 -2.2 meters off of the floor and at a distance of 1.8 meters from center line of the test vehicle (FIG. 5). A digital CCD camera 22 was mounted at a distance of about 3.3 meters from windshield 24 centerline (FIG. 6). Ambient lighting was maintained in the room via fluorescent light fixtures. Metal halide light sources were introduced to determine any potential interference with vision system. An activator containing a luminescent agent was applied to the entire flange surface of the windshield opening 24 (FIG. 7). Reflected pixel density detected by a PC-based vision system was used as qualifier for “pass/fail” criteria (FIG. 8). The results showed that performance of the system was affected by lighting configuration, i.e., light intensity and influence of ambient lighting, as well as camera counts, locations, and lens or filter configurations. Findings showed that light intensity and wavelength are key parameters in successful detection, particularly on dark painted surfaces (see FIG. 9, showing detection of the activator with luminescent agents, as well as zones of application that were intentionally left blank 26). Other embodiments may include, without limitation, changes in camera locations and distance from subject and expansion of system to include detection of front, rear and side glass or flange applications. Light intensity, camera number and location, lenses, and filters may be varied as desired to achieve detection of the activator containing the luminescent agent.

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application.

1. A method of preparing a substrate for bonding with an adhesive, comprising the steps of:
providing a composition comprised of an activator and at least one luminescent agent, the activator comprising at least one adhesion promoter;
applying the composition to the substrate;
providing a source of light with specific wavelength as required to excite photo-initiators within the luminescent agent, and
viewing the substrate under the light source to determine the selective distribution of the composition on the substrate,
wherein said activator comprises at least one organo silicon compound and at least one titanium compound.

2. (canceled)

3. (canceled)

4. (canceled)

5. The method of claim 1, wherein said viewing comprises automated viewing means.

6. (canceled)

7. A method of preparing a metal substrate for bonding with an adhesive, comprising the steps of:
providing a composition comprised of an activator and at least one luminescent agent, the activator comprising at least one adhesion promoter;
applying the composition to a metal substrate;
providing a source of light with specific wavelength as required to excite photo-initiators within the luminescent agent, and
viewing the metal substrate under the light source to determine the selective distribution of the composition on the substrate,
wherein said activator comprises at least one organo silicon compound and at least one titanium compound.

8. The method of claim 7, wherein the metal substrate comprises a metal part for vehicular use.

9. (canceled)

10. (canceled)

11. The method of claim 7, wherein said viewing comprises automated viewing means.

12. (canceled)

13. (canceled)

14. A method of preparing a glass substrate for bonding with an adhesive, comprising the steps of:
providing a composition comprised of an activator and at least one luminescent agent, the activator comprising at least one adhesion promoter;
applying the composition to a glass substrate;
providing a source of light with specific wavelength as required to excite photo-initiators within the luminescent agent, and
viewing the glass substrate under the light source to determine the selective distribution of the composition on the substrate,
wherein said activator comprises at least one organo silicon compound and at least one titanium compound.

15. The method of claim 14, wherein the glass substrate comprises a glass part for vehicular use.

16. (canceled)

17. (canceled)

18. The method of claim 14, wherein said viewing comprises automated viewing means.

19. (canceled)

20. (canceled)

21. A method of preparing a metal substrate having a painted layer for bonding with an adhesive, comprising the steps of:
providing a composition comprised of an activator and at least one luminescent agent, the activator comprising at least one adhesion promoter;
applying the composition to a painted layer on a metal substrate;
providing a source of light with specific wavelength as required to excite photo-initiators within the luminescent agent, and
viewing the metal substrate under the light source to determine the selective distribution of the composition on the substrate,
wherein said activator comprises at least one organo silicon compound and at least one titanium compound.

22. The method of claim 21, wherein the metal substrate comprises a metal part for vehicular use.

23. (canceled)

24. (canceled)

25. The method of claim 21, wherein said viewing comprises automated viewing means.

26. (canceled)

27. (canceled)

28. A method of preparing a glass substrate having a ceramic frit for bonding with an adhesive, comprising the steps of:
providing a composition comprised of an activator and at least one luminescent agent, the activator comprising at least one adhesion promoter;
applying the composition to a ceramic frit on a glass substrate;
providing a source of light with specific wavelength as required to excite photo-initiators within the luminescent agent, and
viewing the glass substrate under the light source to determine the selective distribution of the composition on the substrate,
wherein said activator comprises at least one organo silicon compound and at least one titanium compound.

29. The method of claim 28, wherein the glass substrate comprises a glass part for vehicular use.

30. (canceled)

31. (canceled)

32. The method of claim 28, wherein said viewing comprises automated viewing means.

33. (canceled)

34. (canceled)

35. A method of evaluating the application of an activator to a substrate being prepared for bonding with an adhesive, comprising the steps of:
providing a composition comprised of an activator and at least one luminescent agent, the activator comprising at least one adhesion promoter;
applying the composition to a substrate;
providing a source of light with specific wavelength as required to excite photo-initiators within the luminescent agent, and
viewing the substrate under the light source to determine the selective distribution of the composition on the substrate,
wherein said activator comprises at least one organo silicon compound and at least one titanium compound.

36. The method of claim 35, wherein the substrate comprises a metal part for vehicular use.

37. The method of claim 35, wherein the substrate comprises a glass part for vehicular use.

38. The method of claim 35, wherein said viewing comprises automated viewing means.

39. (canceled)
